(19) United States
(12) Patent Application Publication
(10) Pub. No.: US 2020/0408362 A1
(43) Pub. Date: Dec. 31, 2020

(54) FLUID INJECTOR

(71) Applicant: I CHUAN HUANG, CHANGHUA CITY (TW)

(72) Inventor: I CHUAN HUANG, CHANGHUA CITY (TW)

(21) Appl. No.: 16/451,284

(22) Filed: Jun. 25, 2019

(51) Int. Cl. F17C 13/04; F02M 51/06; F02M 51/00; F02M 57/00

(52) U.S. Cl. CPC F17C 13/04; F02M 57/00; F02M 51/005; F02M 51/06

(57) ABSTRACT

A fluid injector for connecting a connection port of a container or tank includes a housing and a transmission mechanism disposed in the housing. The housing has a fluid inlet and a fluid outlet surrounded by an annular wall. A control valve is provided in the housing for opening and closing the fluid inlet. One end of the transmission mechanism is connected to the control valve, and another end of the transmission mechanism is connected to a movable post passing through the annular wall. When the control valve opens or closes the fluid inlet, the transmission mechanism is driven by the control valve, and the movable post extends out of the annular wall to be engaged with the connection port or retracts into the annular wall, thereby determining the connection state of the fluid injector and the connection port and ensuring that the movable post is exactly controlled.

### FIELD OF THE INVENTION

The present invention relates to a fluid delivery device, and more particularly to a connector for delivering a fluid.

### BACKGROUND OF THE INVENTION

After a pipe connector used for delivering a fluid is engaged with the connection port of a container or tank, a valve is opened for outputting the fluid. It is necessary to ensure that the connector is securely connected during the process to avoid leakage of the fluid. If the fluid is flammable or corrosive, it is more necessary to avoid the above situation. Therefore, a conventional fluid injector, as disclosed in Taiwan Utility Model Publication No. M547628, is provided with a cover plate at an outlet of a connector. The cover plate is linked with a pair of movable posts disposed at the outlet of the connector. When the fluid is output, the cover plate is pushed away, and the movable posts extend outward to be engaged with the connection port of the container or tank, so that the connector cannot be pulled out or detached from the connection port, thereby ensuring the connector is securely connected to the container or tank.

In the above conventional structure, the displacement of the movable post is controlled by the cover plate being pushed away by the fluid. When the fluid stops outputting, the cover plate will return to its original position and the movable post is retracted and no longer engaged with the connection port. If the cover plate cannot be smoothly pivoted due to dirt or other unexplained failure, the movable post can no longer move. As a result, the connector cannot be securely connected to the container or tank, or the connector cannot be pulled out from the connection port.

### SUMMARY OF THE INVENTION

The primary object of the present invention is to provide a fluid injector that controls the displacement of a movable post through the opening and closing of a valve to determine the connection state of the connector and the connection port of a container or tank, thereby ensuring that the movable post can be exactly controlled to achieve a smooth operation.

In order to achieve the above object, a fluid injector for connecting a connection port of a container or tank is provided. The fluid injector comprises a housing and a transmission mechanism. The housing has a fluid inlet and a fluid outlet surrounded by an annular wall. A control valve is provided in the housing for opening and closing the fluid inlet. The transmission mechanism is disposed in the housing. One end of the transmission mechanism is connected to the control valve, and another end of the transmission mechanism is connected to a movable post passing through the annular wall. When the control valve opens or closes the fluid inlet, the transmission mechanism is driven by the control valve, and the movable post extends out of the annular wall to be engaged with the connection port or retracts into the annular wall.

In an embodiment, the control valve is a ball valve. The ball valve is provided with a shifting block. The housing is provided with an operating handle connected with the control valve. The operating handle is rotatable between a first position that controls the ball valve to close the fluid inlet and a second position that controls the ball valve to open the fluid inlet. The transmission mechanism includes a shaft member disposed in the housing. The shaft member is pivotally connected with a connecting block. The connecting block has a first end and a second end. The first end is pivotally connected to a connecting rod. The connecting rod is pivotally connected to the movable post. The second end is abutted against the shifting block. When the operating handle is moved to the first position, the shifting block pushes the connecting block, and the connecting rod pulls the movable post to be retracted into the annular wall. When the operating handle is moved to the second position, the shifting block pushes the connecting block, and the connecting rod pushes the movable post to extend out of the annular wall to be engaged with the connection port.

In an embodiment, the annular wall is pivotally connected with a cover plate that normally closes the fluid outlet. The cover plate is pushed away when a fluid is discharged.

### BRIEF DESCRIPTION OF THE DRAWINGS

FIG. 1 is a schematic view of the present invention, showing the structure of the internal ball valve;

FIG. 2 is a cross-sectional view taken along line A-A of FIG. 1;

FIG. 3 is a schematic view of the present invention, showing the operation of the connecting rod;

FIG. 4 and FIG. 5 are schematic views of the present invention when in use.

### DETAILED DESCRIPTION OF THE PREFERRED EMBODIMENTS

Embodiments of the present invention will now be described, by way of example only, with reference to the accompanying drawings.

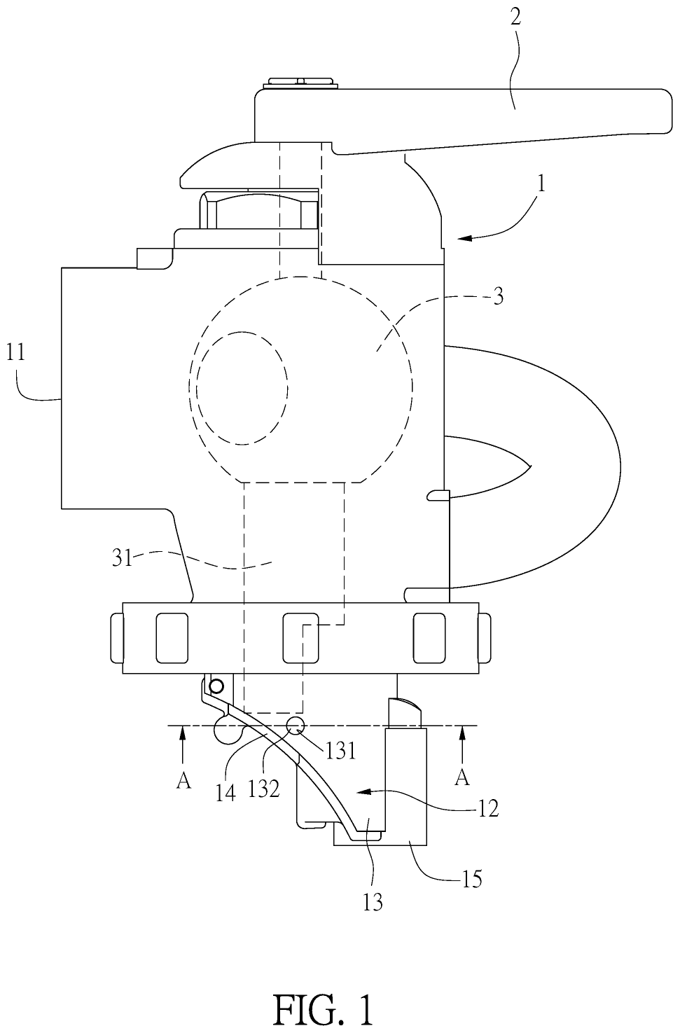

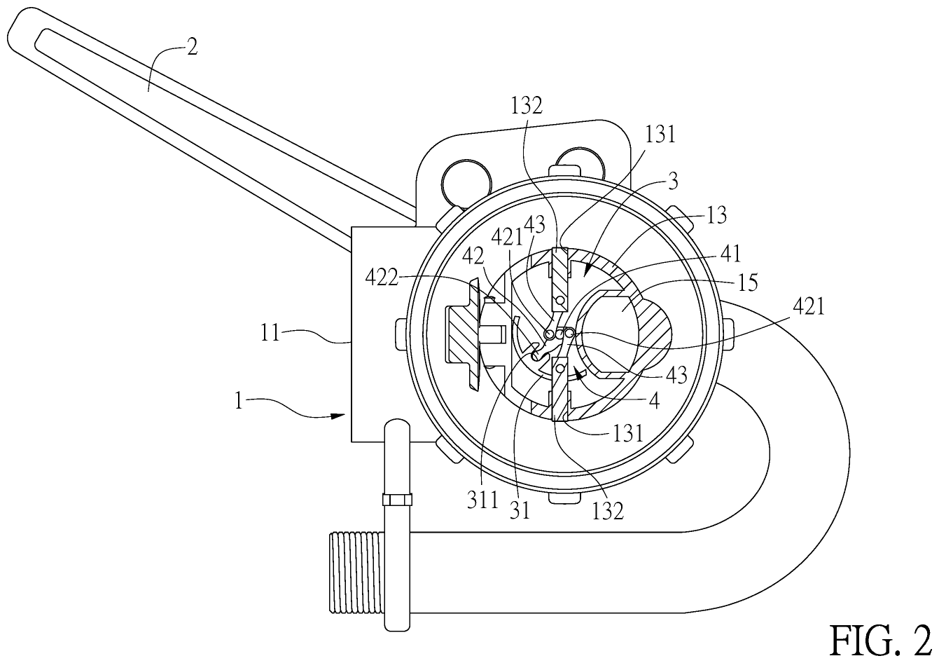

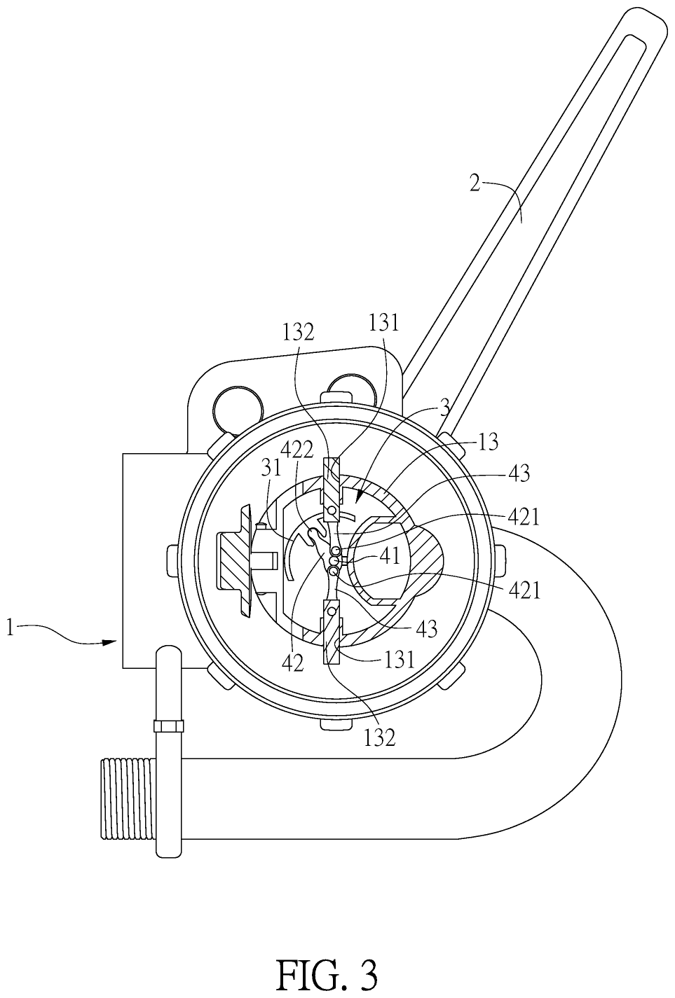

Referring to FIG. 1, FIG. 2 and FIG. 3, the present invention discloses a fluid injector, comprising a housing 1. One side of the housing 1 has a fluid inlet 11 connected to a fluid supply source (not shown) for inputting a fluid into the housing 1. Another side of the housing 1 has a fluid outlet 12 connected to a connection port (not shown) of a container or tank for outputting the fluid to the container or tank. The fluid outlet 12 is surrounded by an annular wall 13. Two opposite sides of the annular wall 13 each have a through hole 131. A movable post 132 is slidably disposed in the through hole 131. The annular wall 13 is pivotally connected with a cover plate 14 that normally closes the fluid outlet 12. The cover plate 14 is pushed away when the fluid is discharged.

A control valve is provided in the housing 1 for opening and closing the fluid inlet 11. The housing 1 is provided with an operating handle 2 connected with the control valve. In this embodiment, the control valve is a ball valve 3. The operating handle 2 is rotated to drive the ball valve 3 to open or close the fluid inlet 11. In detail, when the operating handle 2 is rotated to a first position as shown in FIG. 2, the ball valve 3 closes the fluid inlet 11. When the operating handle 2 is rotated to a second position as shown in FIG. 3, the ball valve 3 opens the fluid inlet 11.

As shown in FIG. 1 and FIG. 2, the ball valve 3 includes an arc-shaped shifting block 31 extending from the lower end of the ball valve 3. The shifting block 31 has a recess 311. When the ball valve 3 is rotated by the operating handle 2, the shifting block 31 is synchronously driven to rotate.

The housing 1 includes a transmission mechanism 4 therein. The transmission mechanism 4 includes a shaft member 41 disposed at a fixed position, a connecting block 42, and two connecting rods 43. In this embodiment, the shaft member 41 is disposed on a fluid recycling pipe 15 located in the housing 1. The connecting block 42 is substantially T-shaped and has two first ends 421 and a second end 422. The two first ends 421 are pivotally connected to the two connecting rods 43, respectively. The connecting rods 43 are pivotally connected to the movable posts 132, respectively. The second end 422 extends toward the shifting block 31 and abuts against the recess 311.

With the above structure, as shown in FIG. 2, when the operating handle 2 is rotated to the first position, the shifting block 31 moves along with the ball valve 3 and pushes the connecting block 42 to rotate about the shaft member 41, so that the two first ends 421 pull the connecting rods 43 while rotating, and the movable post 132 is pulled to move along the through hole 131 towards the inside of the annular wall 13 and is retracted into the annular wall 13. On the other hand, as shown in FIG. 3, when the operating handle 2 is rotated to the second position, the shifting block 31 moves along with the ball valve 3 and pushes the connecting block 42 to rotate about the shaft member 41, so that the two first ends 421 pull the connecting rods 43 while rotating, and the movable post 132 is pulled to move along the through hole 131 towards the outside of the annular wall 13 and extends out of the annular wall 13.

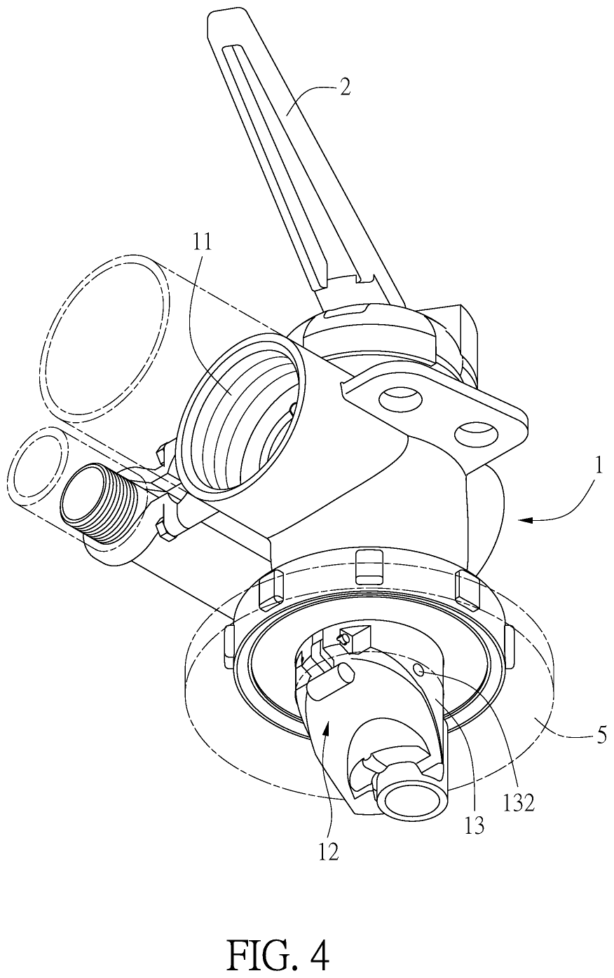

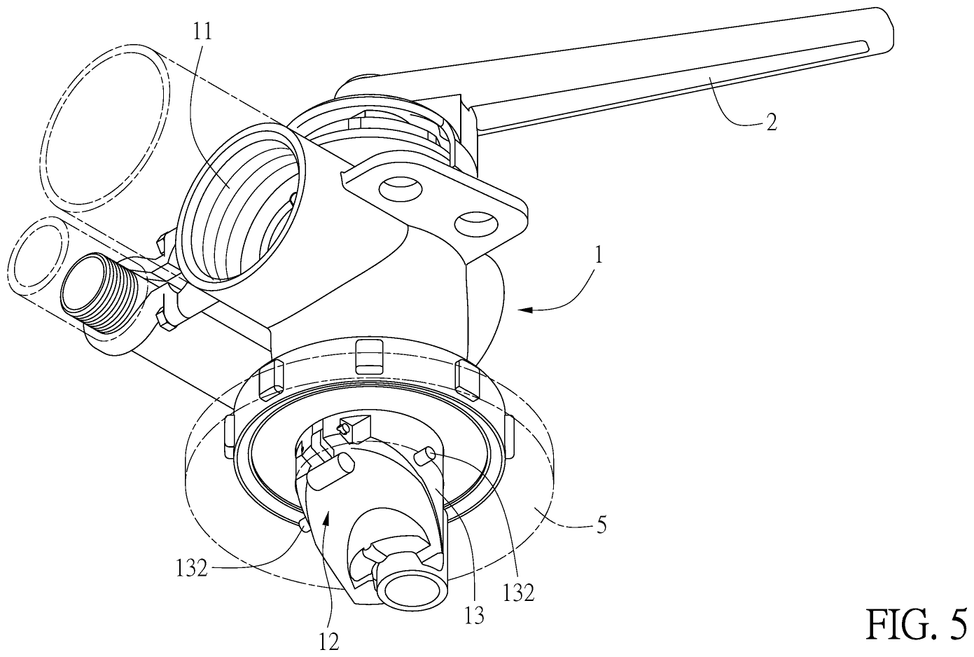

When in use, it is necessary to confirm that the operating handle 2 is in the first position, that is, the position at which the fluid inlet 11 is closed by the ball valve 3. At this time, as shown in FIG. 4, the movable post 132 is retracted into the annular wall 13 by the pulling of the transmission mechanism, and does not extend out of the annular wall 13. Then, the fluid outlet 12 surrounded by the annular wall 13 can be inserted and coupled to the connection port 5 of the container or tank that is the destination to which the fluid is delivered. When the fluid is to be delivered, as shown in FIG. 5, the operating handle 2 is rotated to the second position, that is, the position at which the fluid inlet 11 is opened by the ball valve 3. The movable post 132 extends out of the annular wall 13 by the pulling of the transmission mechanism to be engaged with the bottom edge of the connection port 5, so that the fluid outlet 12 cannot be deliberately pulled out or accidentally detached from the connection port 5, thereby ensuring a stable connection of the fluid outlet 12 and the connection port 5 so as to avoid leakage.

The movable post 132 of the present invention is linked and controlled by the operating handle 2, so that it can be moved exactly, thereby ensuring that the invention is securely connected to the connection port 5 of the container or tank when delivering the fluid and can take out after the delivery operation is completed to achieve a smooth operation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A fluid injector for connecting a connection port of a container or tank, comprising:
a housing, having a fluid inlet and a fluid outlet surrounded by an annular wall, a control valve being provided in the housing for opening and closing the fluid inlet;
a transmission mechanism, disposed in the housing, one end of the transmission mechanism being connected to the control valve, another end of the transmission mechanism being connected to a movable post passing through the annular wall; wherein when the control valve opens or closes the fluid inlet, the transmission mechanism is driven by the control valve, and the movable post extends out of the annular wall to be engaged with the connection port or retracts into the annular wall.

2. The fluid injector as claimed in claim 1, wherein the control valve is a ball valve, the ball valve is provided with a shifting block, the housing is provided with an operating handle connected with the ball valve, the operating handle is rotatable between a first position that controls the ball valve to close the fluid inlet and a second position that controls the ball valve to open the fluid inlet; the transmission mechanism includes a shaft member disposed in the housing, the shaft member is pivotally connected with a connecting block, the connecting block has a first end and a second end, the first end is pivotally connected to a connecting rod, the connecting rod is pivotally connected to the movable post, the second end is abutted against the shifting block; when the operating handle is moved to the first position, the shifting block pushes the connecting block, and the connecting rod pulls the movable post to be retracted into the annular wall; when the operating handle is moved to the second position, the shifting block pushes the connecting block, and the connecting rod pushes the movable post to extend out of the annular wall to be engaged with the connection port.

3. The fluid injector as claimed in claim 1, wherein the annular wall is pivotally connected with a cover plate that normally closes the fluid outlet, and the cover plate is pushed away when a fluid is discharged.
